(19) United States
(12) Patent Application Publication
(10) Pub. No.: US 2005/0139409 A1
(43) Pub. Date: Jun. 30, 2005

(54) Vehicle steering coupled weight jacking apparatus

(76) Inventor: Edward M. Bogue, Colchester, CT (US)

Correspondence Address: EDWARD M. BOGUE, 155 AMSTON RD., COLCHESTER, CT, 06415, US

(21) Appl. No.: 10/750,306

(22) Filed: Dec. 31, 2003

(51) Int. Cl. B60R 21/00; B60G 1/00

(52) U.S. Cl. 180/282; 280/124.106

(57) ABSTRACT

A vehicle's suspension determines most of the vehicle's handling characteristics. By coupling the steering angle to proportional weight jacking, control of the vehicle will be enhanced in both normal driving and emergency maneuvers. This improved suspension can be implemented without any electronics, it can be a strictly mechanical system. As the steering wheel is rotated into a turn, the corner balance of the vehicle would change via weight jacking, allowing better turn in. The greater the steering angle, the greater the weight jacking. Simple weight jacking can be used to promote oversteer at low speed and understeer at high speed. Vehicles in a spin or impending spin can also benefit from this invention because suspension characteristics will dynamically change to assist correction of these situations. Race cars would benefit from an increased variance in acceptable suspension adjustments, relative to current technology. This steering coupled compensation requires the driver to make only natural steering corrections, but it allows for more effective control. These dynamic suspension changes can be implemented through mechanical linkage, pneumatic, electric, or hydraulic means.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF INVENTION

This invention relates to vehicle suspension, specifically to an improved design which dynamically changes handling characteristics.

Vehicle suspension design involves many different aspects. One of which is handling characteristics at or near the limits of adhesion.

When driving a vehicle near the limits of adhesion, one of three conditions generally occurs:
a) Understeer: This is when the front tires have reached the limit adhesion before the rear. When additional steering input is applied to turn more into a corner, little to no additional turning of the car occurs. The best way to get an understeering car to turn into the corner is to lift off the gas or apply the brakes, neither solution is desirable, especially in racing applications.
b) Oversteer: This is when the rear tires have reached the limit adhesion before the front. When additional steering input is applied to turn more into a corner, more turning of the car occurs than would normally be expected. This unstable condition often leads to a spin, and is very undesirable in almost all conditions.
c) Neutralsteer: This is when the front and rear tires have reached the limit adhesion at the same time. This is the most desirable handling condition. It allows for the fastest speed through most corners and gives the best feel to the driver of a vehicle.

Automobiles have a tendency to understeer at low speeds, and oversteer at high speeds. In order to avoid dangerous oversteer condition at high speeds, automobile designers must somehow create neturalsteer at the high speeds. This is generally done using one of following methods:
1) Tune the suspension using shocks, springs, and anti-swaybars to remove the possibility of oversteer. This tuning will soften the rear roll resistance and/or increase the front roll resistance. This causes excessive amounts of understeer at lower speeds, leaving poor low speed handling characteristics. This option is how most street cars are tuned.
2) Use aerodynamic devices to create more rear down force than front down force. In general these devices are only useful at high speeds. This is a good option for very high speed cars and race cars, but sometimes not practical or possible due to body designs or by race class rules.
3) Install an electronic active suspension system in the automobile. These systems are generally prohibited in racing. Most attempts to create active suspensions for street cars have led to high cost, high maintenance, and low reliability.

Method “3” described above is where much work has been done since computers became practical in vehicle control. U.S. Pat. No. 6,564,129 May 2003, is one which addresses promoting low speed oversteer, and high speed understeer. It is based on using sensors for vehicle speed, throttle actuator position, brake actuator position and lateral acceleration. This data is then gathered into a computer, which makes a decision on what corrective action to make. A computer then sends a signal to the appropriate actuator on the vehicle. The vehicle suspension is controlled by variable an antisway apparatus, or variable dampers.

Weight jacking is an increase of the weight on a pair of diagonal tires, and a corresponding decrease on the other diagonal pair. The diagonal pairs on a four wheel vehicle are, left front-right rear, and right front-left rear. In most vehicles the ideal balance is for both diagonals to be of equal weight. If the diagonal weights are not equal, the handling balance of the vehicle becomes different in left turns compared to right turns. Weight jacking affects vehicle balance due to a general property of tires; as the vertical load on a tire is increased, the coefficient of friction of that tire decreases. An example of weight jacking would be having the left front-right rear diagonal increase in vertical load, and the right front-left rear diagonal decrease in vertical load. This vehicle would now understeer in right turns, and oversteer in left turns.

### BRIEF SUMMARY OF INVENTION

In accordance with the present invention, a vehicle suspension design has been invented which allows for the steering to be coupled to the suspension, causing dynamic weight jacking, allowing for changing handling characteristics. An incremental clockwise rotation of the steering wheel (from the driver's perspective) will cause weight jacking to incrementally increase weight on the right front and left rear tires, and decrease weight on the left front tire and right rear tire. An incremental counterclockwise rotation of the steering wheel (from the driver's perspective) will cause weight jacking to incrementally increase weight on the left front and right rear tires, and decrease weight on the right front tire and left rear tire. The greater the steering angie the greater the weight jacking. This can produce a neutral steering vehicle at both high and low speeds because there is a correlation (at the limits of adhesion) between steering angle and speed. The greater the steering angle the lower the speed (at the limits of adhesion), and the lesser the steering angle the higher the speed (at the limits of adhesion). This simple correlation between speed and steering angle (at the limits of adhesion), removes the need to measure speed using a sensor and electronics. The removal of the speed sensor and electronic control and subsequent replacement with a direct correlation between steering angle and weight jacking gives the driver improved control. This enhanced control will assist the driver by keeping optimal vehicle balance in normal driving, and allow for improved stability in the event of a spin or impending spin.

### OBJECTS AND ADVANTAGES

An inexpensive, and reliable dynamic vehicle suspension system not requiring computer control or electronics which will provide the following:
a) the desired handling characteristics (normally neutral steering) at both high and low speed;
b) a suspension which will dynamically change based on drivers input to the steering wheel;
c) enhanced emergency control, especially in the event of a spin.

Still further objects and advantages will become apparent from a consideration of the ensuing description and drawings.

### BRIEF DESCRIPTION OF THE SEVERAL VIEWS OF THE DRAWING

FIG. 1 (A,B,C)

Perspective views of the left front suspension on preferred embodiment with the wheel pointed straight.
10 WHEEL
11 A-ARM
12 STEERING ARM
13 TIEROD
14 PIVOT BOLT
15 ROCKER
16 LINK
17 DROP LINK
18 ANTI-SWAYBAR
19 CHASSIS
20 STEERING RACK
21 BALL JOINT
22 STRUT
23 STEERING COLUMN
24 STEERING WHEEL

FIG. 2 (A,B)

Perspective views of the left front suspension on preferred embodiment with the wheel pointed left.
10 WHEEL
11 A-ARM
12 STEERING ARM
13 TIEROD
14 PIVOT BOLT
15 ROCKER
16 LINK
17 DROP LINK
18 ANTI-SWAYBAR
19 CHASSIS
20 STEERING RACK
21 BALL JOINT
22 STRUT

FIG. 3

A perspective view of the left front suspension on alternative embodiment using eccentric bearing with wheels pointed straight.
10 WHEEL
11 A-ARM
12 STEERING ARM
13 TIEROD
17 DROP LINK
18 ANTI-SWAYBAR
19 CHASSIS
20 STEERING RACK
21 BALL JOINT
22 STRUT
30 LINK
31 ECCENTRIC BEARING

FIG. 4

A perspective view of the left front suspension on an alternative embodiment using an eccentric bearing with wheels turned left.
10 WHEEL
11 A-ARM
12 STEERING ARM
13 TIEROD
17 DROP LINK
18 ANTI-SWAYBAR
19 CHASSIS
20 STEERING RACK
21 BALL JOINT
22 STRUT
30 LINK
31 ECCENTRIC BEARING

FIG. 5

A perspective view of the left front suspension on alternative embodiment using hydraulics with wheels pointed straight.
10 WHEEL
11 A-ARM
12 STEERING ARM
13 TIEROD
18 ANTI-SWAYBAR
19 CHASSIS
20 STEERING RACK
21 BALL JOINT
22 STRUT
40 HYDRAULIC DROPLINK
41 HYDRAULIC CYLINDER
42 HYDRAULIC LINE

FIG. 6

A perspective view of the left front suspension on a strut type suspension with jacking device with wheels pointed straight.
19 CHASSIS
22 STRUT
50 JACKING DEVICE
51 SPRING

### DETAILED DESCRIPTION OF THE INVENTION

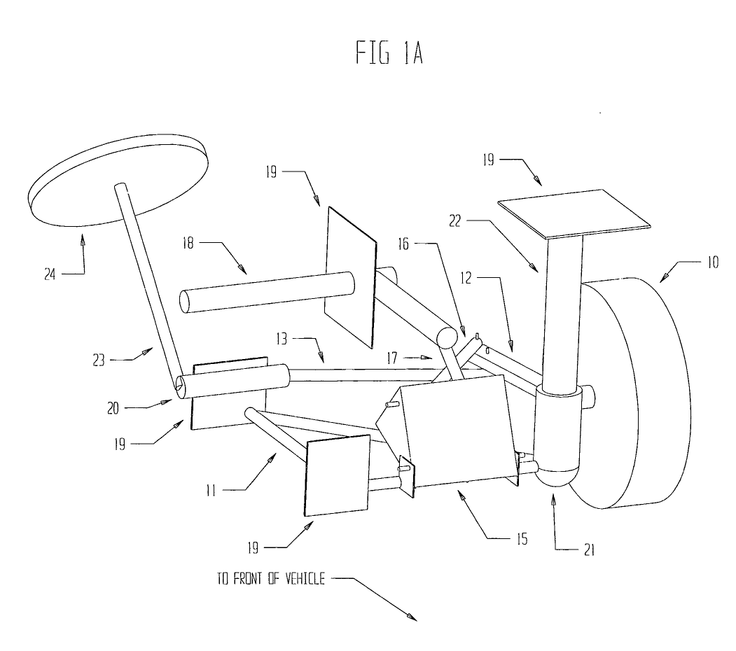

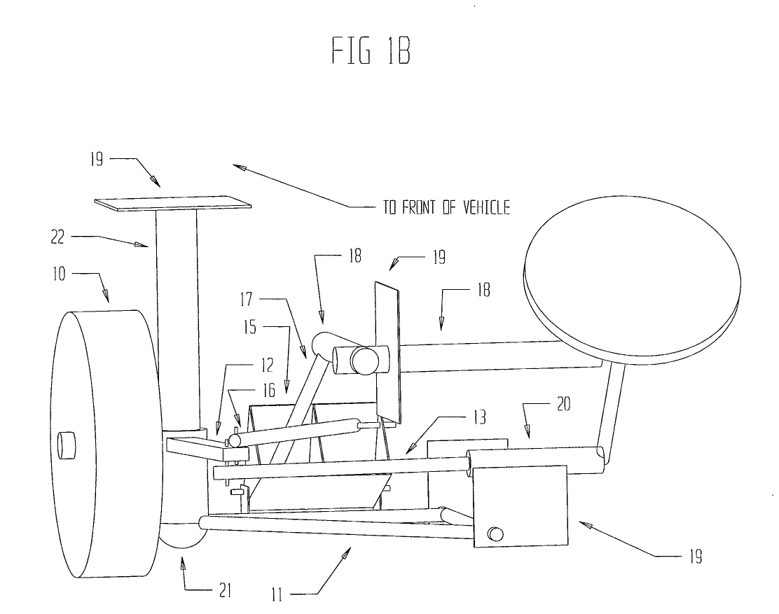

### FIGS. 1(A,B,C)—PREFERRED EMBODIMENT

A Preferred embodiment of the suspension device of the present invention is illustrated in FIGS. 1A, 1B, and 1C.

The chassis (19) is a rigid structure to which A-arm(11), anti-swaybar(18), steering rack(20), and strut(22) are mounted. The A-arm(11) pivots on the chassis(19) upon an axis which allows vertical travel. The steering arm(12) is connected to the ball joint(21) which is then connected to the A-arm(11). The ball joint(21) allows the steering arm(12) to rotate relative to the A-arm(11) The steering arm(12) is attached to the lower part of the strut(22). The steering wheel(24) is connected to the steering column(23) which connects to the steering rack(20). The steering rack(20) is connected to the tierod(13) which is connected to a mount on the steering arm(12). The wheel (10) is attached at the lower part of the strut(22). The rocker(15) is mounted to the A-arm(11) with the pivot bolt(14). The link(16) has a spherical bearing at each end. The link(16) is attached the steering arm(12) at one end and the rocker(15) at the other. Drop link(17) has a spherical bearing at each end, and is connected to rocker(15) at one end, and anti-swaybar(18) at the other end. The anti-swaybar is allowed to rotate relative to the chassis(19). The figures and description referred to above are for the left side of the car, the right side is a mirror image of the left.

Operation main embodiment (FIGS. (1a,b,c),(2a,b)): The A-arm(11) rotates at the chassis(19) mount to allow the lower ball joint(21) and steering arm(12) to move vertically. The strut(22) is a vertical damper which maintains the steering arm(12) and wheel(10) in the correct alignment in relative to the chassis(19). Rotation of the steering wheel causes the steering rack(20) and the tierod(13) to the left or right direction, which rotates the steering arm(12) and wheel(10). The steering arm(12) and wheel(10) will rotate upon an axis defined by the top of the strut(22) and the ball joint(21).

The operation of the following parts are the key to this invention. A rocker(15) is mounted to the front edge of the lower A-arm(11). This rocker(15) is allowed to pivot on the pivot bolt(14). A link(16) which connects the steering arm(12) to the rocker(15), forces rotation of the rocker(15) when the steering angle is changed through movement in the steering rack(20). The anti-swaybar(18) is of the standard type with a drop link(17) connected to the suspension. In a standard suspension the lower connection of the drop link(17) is connected to the A-arm(11). In this design the lower connection of the drop link(17) is connected to the rocker(15), the rocker(15) is connected to the A-arm(11). When the rocker(15) is rotated by movement of the steering rack(20), the drop link(17) is moved vertically relative to the A-arm(11). This creates a weight jacking effect on the vehicle. The amount of weight jacking can be made adjustable by allowing a changing the mounting locations of the above links.

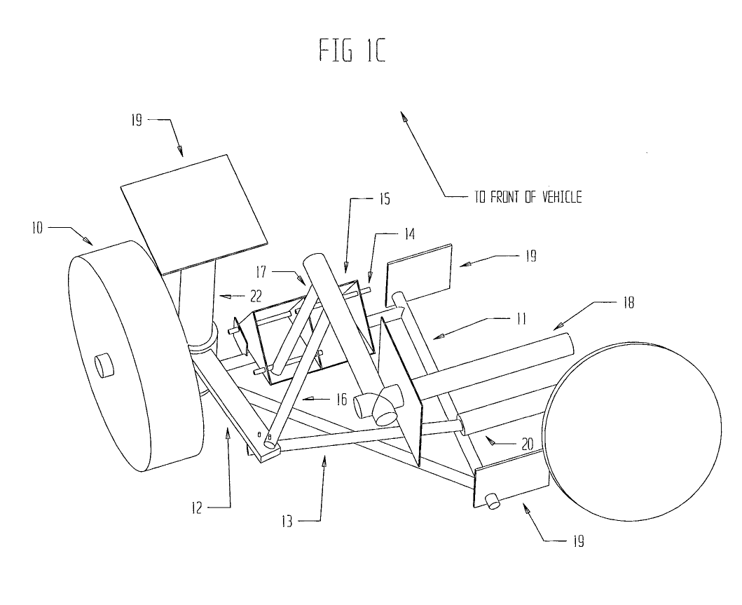

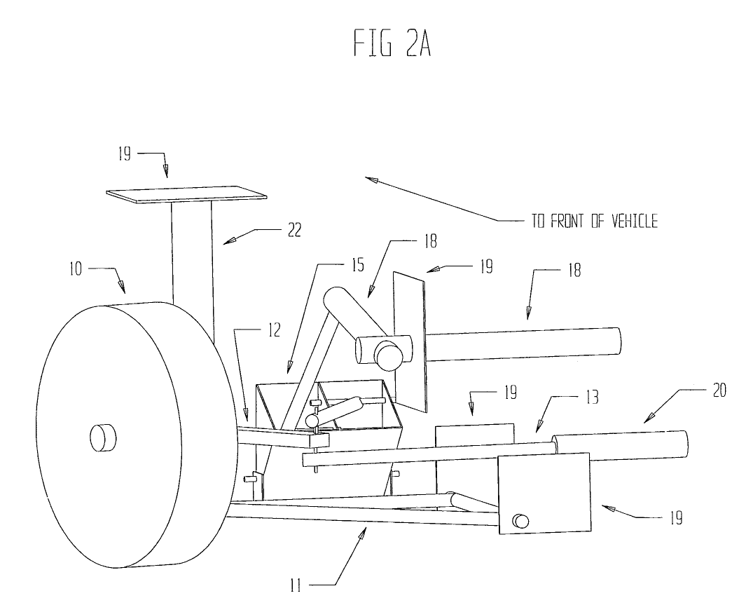

FIG. 1(a,b,c) illustrates the suspension with the wheel(10) pointed straight. FIG. 2(a,b) illustrates the same suspension with the wheel(10) turned counterclockwise, as in a left hand turn. The tierod(13) is moved to the right. The steering arm(12) is rotated counterclockwise. The rocker(1 5) is rotated more up. The drop link(17) is now moved farther away from the A-arm(11), thus pushing up on the anti-swaybar(18). In the right side suspension the opposite would occur, having the drop link pull down on the anti-swaybar. This torquing of the anti-swaybar(18) will cause weight jacking of the vehicle. The more the steering is turned, the greater this weight transfer will be.

This example of a left turn will cause more weight to be transferred onto the left front wheel, and right rear wheel. Weight will be removed on the right front wheel and left rear wheel. As this weight jacking occurs understeer in the car will be reduced(oversteer will be increased). The greater the steering angle, the greater this reduction in understeer(increase in oversteer).

This embodiment is symmetrical left to right, thus the opposite weight transfer would occur in a right hand turn. This rotation would have the same desirable effect of reduced understeer(increased oversteer) as the steering angle is increased.

This reduction in understeer(increase in oversteer) with increasing steering angle is beneficial for these two reasons when in a controlled turn at the limit of adhesion.

1)When an understeering car is in a turn at the limit of adhesion, any attempt to add more steering input will have no effect on direction of the car. With this apparatus installed, when an understeering car is in a turn at the limit of adhesion, an attempt to add more steering input will have an effect of turning the car more in the corner. With this apparatus the suspension becomes self compensating, a fine tuning of suspension characteristics will occur with natural driver inputs.

2) The natural tendency for cars to understeer at low speed and oversteer at high speed is greatly reduced. At the limit of adhesion a high speed turn will have a large radius(small steering angle therefore understeer) and a low speed turn will have a small turning radius(high steering angle therefore more oversteer). This correlation between steering angle and vehicle speed at the limit of adhesion, allows the device to compensate for the natural tendency for cars to understeer at low speed and oversteer at high speed.

There is another beneficial effect of this suspension device, enhanced car control in the event of a spin. For example in a clockwise spin, the proper reaction would be to turn the steering wheel counterclockwise(same as the above left hand turn). This example of a corrective action to the spin will cause more weight to be transfered onto the left front wheel, and right rear wheel. Weight will be removed on the right front wheel and left rear wheel. This weight transfer translates to more rear traction, thus the spin can be much more easily controlled.

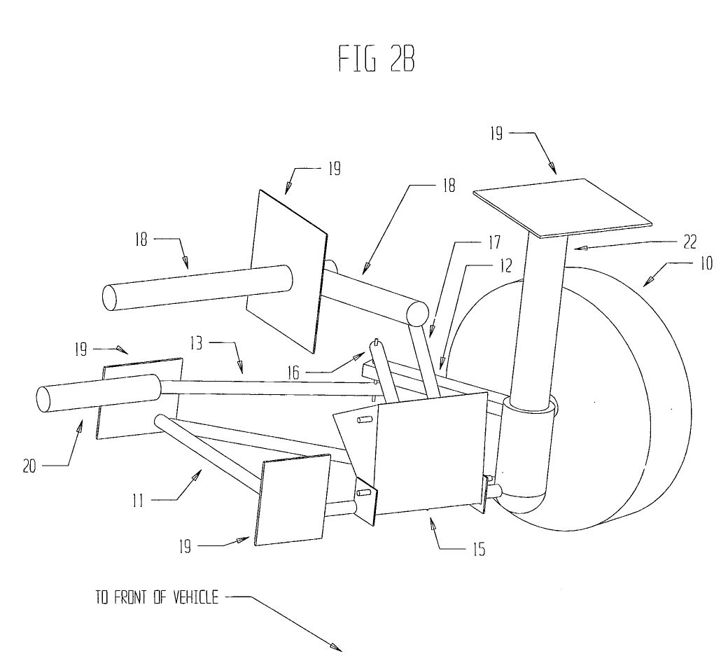

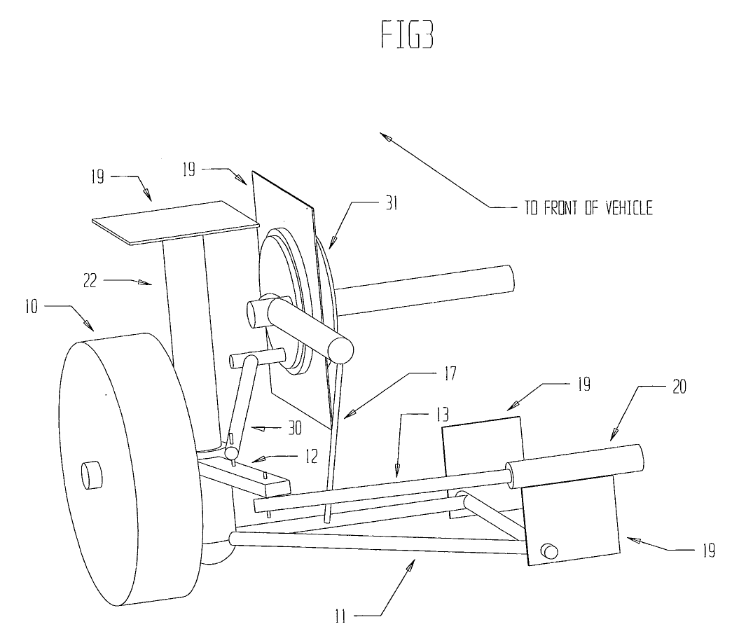

Description and operation of alternative embodiment(FIG. 3,4): This alternative embodiment is similar to the previous embodiment except for the rocker(15) and connected parts. In this example the rocker's function is replaced with the anti-swaybar(18) being mounted in an eccentric bearing(31). Link(30) is connected to the steering arm(12) at one end and the eccentric bearing(31) at the other end. The eccentric bearing(31) is mounted to the chassis( 19). The anti-swaybar(18) passes through the eccentric bearing(31) at a point off center. The upper end of the drop link(17) mounts to the anti-swaybar(18), and the lower end of the drop link(17) mounts to the A-arm(11). The figures and description referred to above are for the left side of the car, the right side is a mirror image of the left.

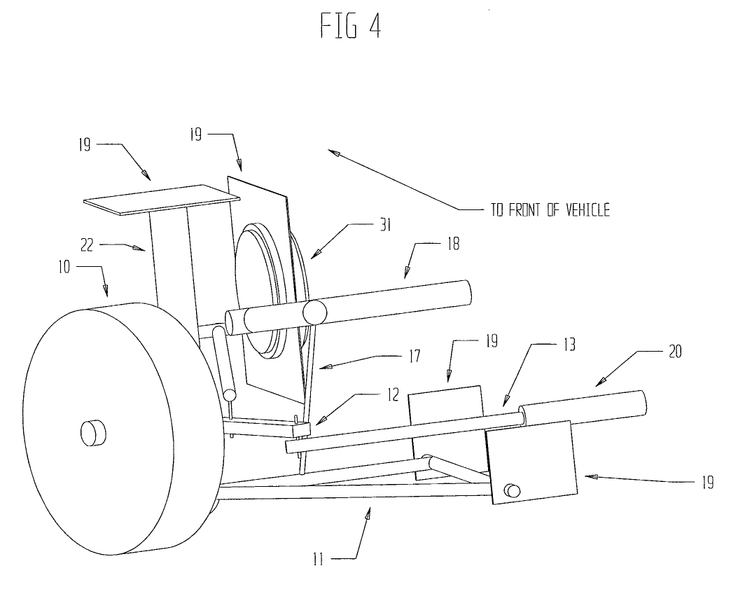

This embodiments operation is similar to the previous preferred embodiment. FIG. 4 shows the same suspension as FIG. 3, but with the wheel turned counterclockwise. In this embodiment the anti-swaybar(18) itself moves down relative to the chassis(19) to create the weight jacking effect. When the wheel(10) is turned, the link(30) moves forward, rotating the eccentric bearing(31). When the eccentric bearing(31) rotates, the anti-swaybar(18) (which is mounted though the bearing) moves vertically and horizontally. The vertical movement creates the weight jacking coupled to the steering angle. This weight jacking will have the same benefits discussed earlier, enhanced vehicle control, and recovery from spins.

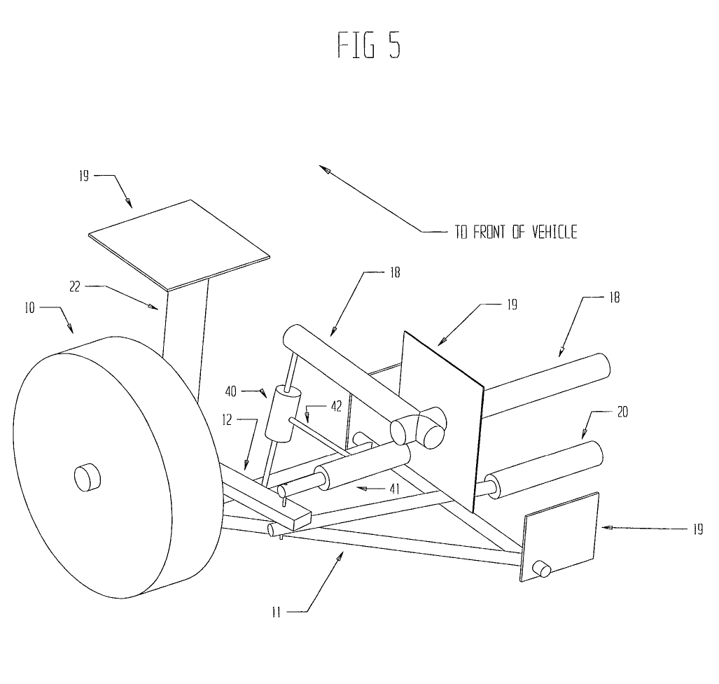

Description and operation of second alternative embodiment(FIG. 5): This embodiment is similar to a standard suspension except for as little as two major parts. The first part is a hydraulic cylinder(41) connected between the chassis(19) and the steering arm(12). The second change is the replacement of drop link(17) with a hydraulic drop link(40). The hydraulic cylinder(41) and hydraulic drop link(40) are connected with hydraulic line(42). As the steering rack(20) is moved to the left (as in a right hand turn), fluid is forced into hydraulic cylinder(41), and fluid is removed from hydraulic droplink(40). This has the effect of shortening the droplink(40) creating a weight jacking effect on the vehicle. A movement to the right of the steering rack(20) (as in a left hand turn), will do the opposite, transferring fluid from the hydraulic cylinder(41) to the hydraulic drop link(40). This will lengthen the hydraulic drop link(40), with the weight jacking effect being the opposite of a right hand turn. The weight jacking associated with this implementation will have the same beneficial effects as the previous implementations.

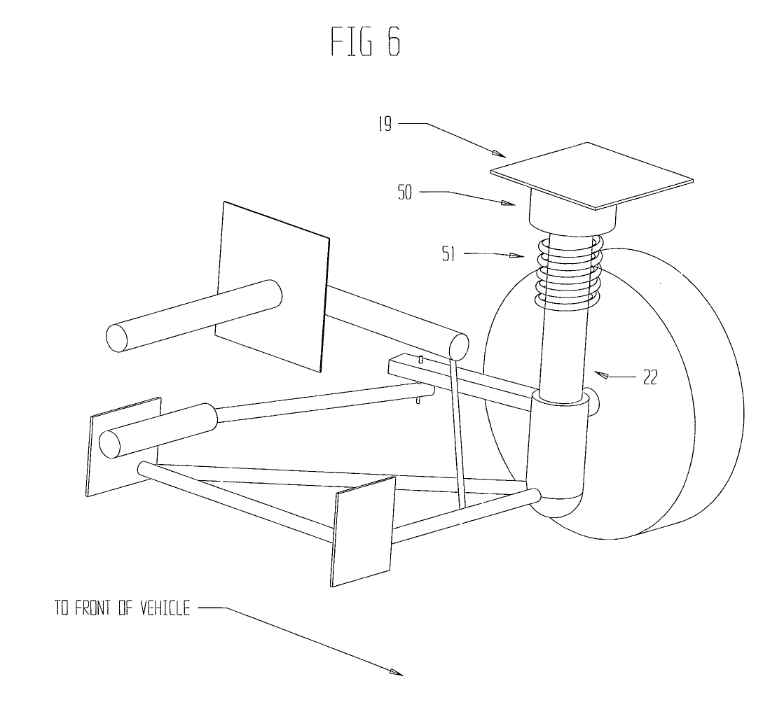

Description and operation of third alternative embodiment(FIG. 6): In FIG. 6 a strut and coil spring type suspension is shown with a weight jacking device(50). This weight jacking device can be a mechanical device such as a threaded collar, hydraulic, or pneumatic device. This weight jacking device(50) can be placed at the top of the strut (22) to move the top of the spring(51) vertically relative to the chassis(19) with rotation, thus changing the spring(51) preload. The device should designed to increase the distance between the strut(22) and chassis(19) on the left front when the steering wheel is turned counterclockwise. The device should designed to decrease the distance between the strut(22) and chassis(19) on the right front when the steering wheel is turned counterclockwise. When the steering wheel is turned clockwise, the opposite should occur. The weight jacking associated with this implementation will have the same beneficial effects as the previous implementations.

CONCLUSION: Accordingly, the reader will see the suspension device in this invention will:
Reduce high speed oversteer.
Reduce low speed understeer.
Create a dynamic closed loop suspension which uses the driver's input to change its characteristics.
Allow for enhanced control of a spinning vehicle.
Be cost effective to initially build and maintain through the vehicle's life.
Have very high reliability due to its simplicity; not requiring sensors or electronics.

Although the description above contains many specifications, these should not be construed as limiting the scope of the invention, but merely providing illustrations of some of the presently preferred embodiments of this invention. As a means of cost savings only one side of the suspension may have the weight jacking device, but in some designs this may have non-symmetrical results on left and right turns. Power assist can be implemented on the weight jacking mechanism so the steering feel remains the same with a change in vertical load. There are many different types of suspension on which this invention can be implemented; i.e., double A-arm, trailing arm, solid axle, and others. The location of the anti-swaybar could also greatly change how it is implemented. It can be implemented on different locations of the anti-swaybar, in front of the wheel, behind the wheel, through the body, under the body, etc. The steering input can come from movement of the any steering member ,steering arm, tierod, steering rack, steering column, or any suspension member which moves or rotates with the steering system. The steering coupled apparatus can be on the front suspension, the rear suspension, or both front and rear suspensions. The device can be connected to the main suspension springs or independent secondary springs, changing the springs preload to create the weight jacking. These dynamic suspension changes can be implemented through mechanical linkage, pneumatic, electric, or hydraulic means. The weight jacking system can be made adjustable, to allow for a variable amount of compensation versus steering angle.

Thus, the scope of the invention should be determined by the appended claims and their legal equivalents, rather than by the examples given.

1. A vehicle suspension system capable of providing:
a) means for a dynamic weight jacking with said weight jacking being controlled by steering angle, and
b) whereby an incremental clockwise rotation of the steering wheel will cause said weight jacking to incrementally but not necessarily linearly increase weight on the right front tire and left rear tire, and decrease weight on the left front tire and right rear tire, and
c) whereby an incremental counterclockwise rotation of the steering wheel will cause said weight jacking to incrementally but not necessarily linearly increase weight on the left front tire and right rear tire, and decrease weight on the right front tire and left rear tire.

2. The suspension in claim 1 whereby the means of weight jacking the vehicle is accomplished by changing the geometry of an anti-swaybar.

3. The suspension in claim 2 whereby the change in geometry of said anti-swaybar is controlled by a mechanical linkage.

4. The suspension in claim 3 whereby said mechanical linkage connects a steering member or suspension member which moves with movement of the steering to a rocker assembly. Said rocker assembly is then connected to said anti-swaybar or a droplink for said anti-swaybar.

5. The suspension in claim 3 whereby said mechanical linkage connects a steering member or suspension member which moves with movement of the steering, to an eccentric mount for said anti-swaybar. Said eccentric mount is configured to move the anti-swaybar relative to a chassis support, with movement of the steering.

6. The suspension in claim 1 whereby the means of changing said dynamic weight jacking is accomplished through the use of one or more of a secondary spring.

7. The suspension in claim 1 whereby the means of changing said dynamic weight jacking is accomplished through a change in preload of one or more of a main suspension spring.

8. The suspension in claim 7 whereby said change in preload of said main suspension spring is accomplished through a threaded collar on a strut assembly.

9. The suspension in claim 1 whereby said means of weight jacking the vehicle allows variable adjustment for the amount of weight jacking for a given change in steering angle.

10. The suspension in claim 2 whereby the geometry of said anti-swaybar is changed through a variable length drop link.

11. The suspension in claim 10 whereby said drop link contains a hydraulic cylinder.

12. The suspension in claim 1 whereby the means of changing said dynamic weight jacking is implemented through mechanical means.

13. The suspension in claim 1 whereby the means of changing said dynamic weight jacking is accomplished through pneumatic means.

14. The suspension in claim 1 whereby the means of changing said dynamic weight jacking is accomplished through hydraulic means.

15. The suspension in claim 1 whereby the means of changing said dynamic weight jacking is accomplished through electric means.

16. A vehicle suspension assembly capable of:
a) transmitting force applied at a steering wheel to a change in vertical load at a wheel, and
b) whereby an incremental clockwise rotation of said steering wheel will cause said change in vertical load to incrementally but not necessarily linearly increase vertical load on the right front tire and left rear tire, and decrease vertical load on the left front tire and right rear tire, and
c) whereby an incremental counterclockwise rotation of said steering wheel will cause said change in vertical load to incrementally but not necessarily linearly increase on the weight weight left front tire and right rear tire, and decrease weight on the right front tire and left rear tire.

17. The suspension in claim 16 whereby the means of said change in vertical load is implemented through mechanical means.

18. The suspension in claim 16 whereby the means of said change in vertical load is accomplished through pneumatic means.

19. The suspension in claim 16 whereby the means of said change in vertical load is accomplished through hydraulic means.
